(19) United States
(12) Patent Application Publication
(10) Pub. No.: US 2002/0172518 A1
(43) Pub. Date: Nov. 21, 2002

(54) Universal pan & tilt apparatus

(76) Inventor: Richard Cooper Watson, Fayetteville, TN (US)

Correspondence Address: Richard Cooper Watson, 148 Ashton Cir., Fayetteville, TN, 37334, US

(21) Appl. No.: 09/860,110

(22) Filed: May 17, 2001

(51) Int. Cl. G03B 17/00

(52) U.S. Cl. 396/428

(57) ABSTRACT

An apparatus for providing pan and tilt positional control to a wide range of devices, such as lighting fixtures, surveillance cameras, video monitors, fans and speakers. The invention utilizes the mounting bracket of the device being positioned to facilitate a simplified pan and tilt arrangement. The pan and tilt motors are mounted in a singular motor housing that is affixed to the top of the mounting bracket of the device being positioned. The pan motor's rotational force is translated into a panning action by means of a threaded drive shaft that passes through the top of the motor housing and is affixed to a stationary support structure. During panning operations the motor housing and the device being positioned rotate about the pan axis. The tilt motor's rotational force is translated into a tilting action by means of a wire cable and small drum. The wire cable spools out from around the drum for attachment to the device being positioned at a point near the end of the device that falls towards the ground when the device is allowed to tilt freely. During tilting operations the wire cable spools in and out to tilt the device up and down. By utilizing the mounting bracket of the device being positioned and the innovative wire cable tilt arrangement the invention presents a simpler, more cost effective and universally applicable pan and tilt assembly.

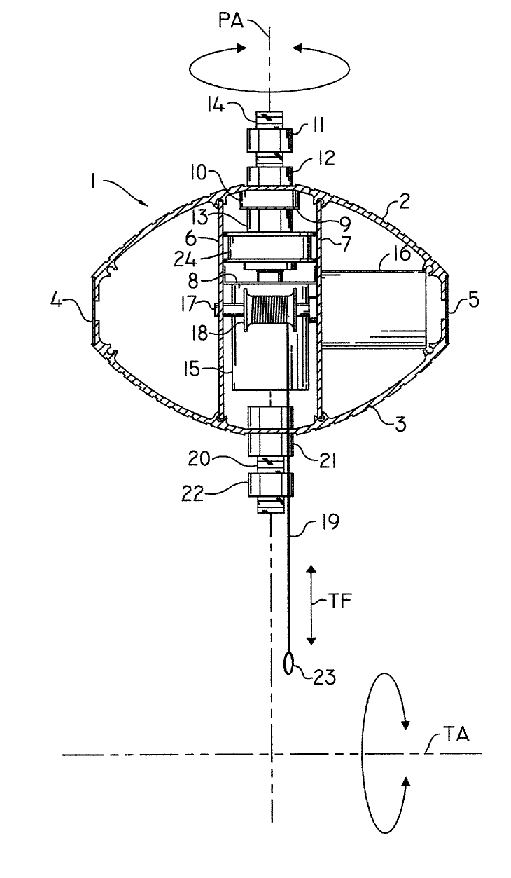

### CROSS-REFERENCE TO RELATED APPLICATIONS “Not Applicable”

### STATEMENT REGARDING FEDERALLY SPONSORED RESEARCH OR DEVELOPMENT “Not Applicable”

### REFERENCE TO A “MICROFICHE APPENDIX”“Not Applicable”

### BACKGROUND OF THE INVENTION

1) Field of the Invention

The present invention relates to pan and tilt mechanisms used for positional control over a device, such as a lighting fixture.

2) Description of Related Art

Pan and tilt units enable a device to be oriented or aimed in a particular direction. Common applications involve the remote positioning of lighting fixtures, surveillance cameras and video monitors.

Pan and tilt units generally contain a pan motor for rotating the device about a pan axis and a tilt motor for rotating the device about a tilt axis that is perpendicular to the pan axis. One common approach to achieving a pan and tilt function is to mount the tilting motor assembly directly to the panning motor assembly as described in U.S. Pat. No. 5,463,432 to Kahn. In another example the pan and tilt motors are mounted to a stationary base structure and coupled by means of pinions, shafts and gears to pan and tilt platforms as described in U.S. Pat. No. 6,027,257 to Richards et al.

While these types of pan and tilt systems allow for a good range of motion, they are complex and task specific. They are not equipped or intended for retrofitting to existing devices outside their scope of design. For example, the same pan and tilt unit used to position a video camera would not be capable of positioning a large lighting fixture. Furthermore, these designs require that the tilting assembly be manufactured as an integral part of the pan and tilt unit resulting in added cost, complexity, decreased reliability and undue limitations as to the size and type of device that can be tilted by the assembly.

The present invention addresses the need in the art for a simpler, more cost effective and universally applicable pan and tilt apparatus.

### BRIEF SUMMARY OF THE INVENTION

The invention is a motorized pan and tilt apparatus. The mechanism enables a vast range of new and existing devices to be fitted for positional control.

In a preferred embodiment of the invention, the mounting bracket of the device being positioned is utilized to facilitate a simplified pan and tilt arrangement. The pan and tilt motors are mounted in a singular motor housing that is affixed to the top of the mounting bracket.

The pan motor's rotational force is coupled to a separate and stationary mounting bracket by means of a threaded drive shaft that passes through the top of the motor housing. During panning operations the motor housing and the device being positioned rotate about the pan axis.

The tilt motor's rotational force is converted to a tilting action by means of a wire cable and drum arrangement. The wire cable spools out from the invention for attachment to the device being positioned at a point near the front or back of the device that falls towards the ground when the device is allowed to tilt freely. During tilting operations the wire cable winds and unwinds around a small drum that is mounted to the tilt motor's drive shaft. As the wire cable winds and unwinds from around the small drum, the device being positioned tilts upward and downward about the tilt axis.

### BRIEF DESCRIPTION OF THE SEVERAL VIEWS OF THE DRAWING

The following detailed description will help to better illustrate the uniqueness of the invention and the resulting advantages when taken in conjunction with the accompanying drawing in which:

a frontal view is shown, with the front plate removed, illustrating an embodiment of the invention.

### DETAILED DESCRIPTION OF THE INVENTION

Referring to the accompanying drawing, a pan and tilt apparatus is provided for positioning or aiming of a vast range of devices requiring positional control, such as lighting fixtures, surveillance cameras, fans, video monitors and speakers. The apparatus is ideally suited to positioning devices with an integrated tilt-mounting bracket, such as those found on theatrical lighting fixtures. Positional commands may be sent to the apparatus from an external source, such as a computer, or generated by internal electronics.

The apparatus does not require a separate pan base and tilt platform as found in other pan and tilt designs. The pan and tilt motors 15, 16 are housed in a single enclosure referred to as the motor housing 1 which consist of sides 2, 3, 4 and 5. Front and back end plates are incorporated but not shown for simplicity. Three support structures are included in the motor housing 1, cross brace 6, tilt motor mount 7 and pan motor mount 8.

The pan motor's rotational force is linked to a threaded drive shaft 14 by means of a belt and pulley 24. The apparatus is mounted to a stationary structure, such as a wall or pole, by means of a mounting bracket that is secured to the threaded drive shaft 14 by two nuts 11, 12. The threaded shaft 14 passes through a nut 13, bearing backing plate 9 and a bearing 10 before exiting the motor housing 1. The motor housing 1 is attached to the tilt-mounting bracket of the device being positioned by a threaded bolt 20 and two nuts 21, 22. The motor housing 1 and the device being positioned rotate about a pan axis PA during panning operations.

The tilt motor's rotational force is converted to a tilting force TF by means of a small drum 18 mounted on the tilt motor's drive shaft 17 and a wire cable 19 that is wound around the small drum 18. The cable end 23 is attached to the device being positioned at a point near the end of the device that falls towards the ground when the device is left to balance freely. A cable clamp, I-bolt or other suitable means may be used to fasten the cable end 23 to the device. Activating the tilt motor 16 results in a tilting force TF that raises and lowers the device being positioned along the tilt axis TA of the device.

In the above described embodiment of the invention the pan and tilt motors 15, 16 are dc servo gear head motors. It should be understood that the invention is not limited to dc servo gear head motors and control configurations. It is also understood that the described mounting method for mounting the motor housing 1 to the device being positioned is only representative of a single approach. A person skilled in the art will recognize that other mounting methods and motor types, such as stepper and ac synchronous motor configurations could be implemented.

The described embodiment of the invention represents only one possible configuration. It is understood that one having ordinary skill in the art will recognize additional modifications and improvements. Such modifications and improvements are intended to fall within the scope of the present invention.

The invention claimed is:

1) A pan and tilt apparatus for providing pan and tilt control of a device, the apparatus comprising:
a motor housing having means for attachment to the mounting bracket of the device being positioned;
a threaded drive shaft protruding through the top of the motor housing having means for attachment to a fixed supporting structure;
a pan axis drive motor mounted in the motor housing and drivingly connected to the threaded drive shaft, for rotating the motor housing and device being positioned about a vertical axis; and,
a tilt axis drive motor mounted in the motor housing and drivingly connected to the device being positioned by means of a wire cable and small drum attached to the tilt axis motor's drive shaft, for rotating the device being positioned about a horizontal axis.

2) The pan and tilt apparatus of claim 1 wherein one end of the wire cable is attached to the small drum and the other end is attached to the device being positioned, activation of the tilt axis drive motor results in the wire cable winding or unwinding from around the small drum and a corresponding tilting of the device being positioned about a horizontal axis.
